(19) United States
(12) Patent Application Publication
(10) Pub. No.: US 2009/0145622 A1
(43) Pub. Date: Jun. 11, 2009

(54) Switching cabinet

(76) Inventors: Markus Weber, Haiger (DE); Samuel Klassen, Haiger (DE); Heiko Holighaus, Eschenburg (DE)

Correspondence Address: PAULEY PETERSEN & ERICKSON, 2800 WEST HIGGINS ROAD, SUITE 365, HOFFMAN ESTATES, IL, 60169, US

(21) Appl. No.: 12/313,373

(22) Filed: Nov. 17, 2008

(30) Foreign Application Priority Data
Nov. 27, 2007 (DE) 102007057381.4-34

(51) Int. Cl. H02G 3/08

(52) U.S. Cl. 174/50

(57) ABSTRACT

A switching cabinet with a switching cabinet housing delimited at a top by an upper cover plate and having at least one switching cabinet door on a front surface. A plurality of transport eyes are attached to the top of the switching cabinet housing that can be covered by a detachably fastenable roof. The transport eyes include angle elements that each have one leg which protrudes from the upper cover plate and that has a through bore, and one fastening leg oriented at an angle. The fastening legs of at least a portion of the angle elements each have a fastening region with which they are attached to the top of the switching cabinet housing and a holding region with which they engage behind an edge profile formed onto the roof.

### BACKGROUND OF THE INVENTION

1. Field of the Invention

This invention relates to switching cabinet with a switching cabinet housing delimited at its top by an upper cover plate and having at least one switching cabinet door on its front surface. The top of the switching cabinet housing has a plurality of transport eyes that can be covered by a detachably fastenable roof.

2. Discussion of Related Art

The Rittal Handbook 32, page 879 describes a so-called CS basic housing, which is essentially of a switching cabinet housing with at least one door and an additional mounted weatherproof roof. Switching cabinets of this kind are particularly for outdoor use and should permit the entry of rainwater into the interior of the housing and also permit a certain cooling action when exposed to direct sunlight.

In a known switching cabinet, the weatherproof roof is essentially of a flat roof plate, which is attached to the upper framework of the switching cabinet and its upper cover plate with a separate angle profile. The angle profile is fastened by screw connections to the rear part of the switching cabinet housing, remote from the user. At the side, the weatherproof roof is enclosed by separate side parts that are likewise fastened to the switching cabinet housing and are in turn attached to the angle profile and the cover plate by corner pieces. A separate frontal roof part, connected to the two side parts by corner pieces and that delimits the weatherproof roof toward the front, is screw-mounted to the part of the switching cabinet housing oriented toward the user.

The amount of assembly effort and the number of parts are not insignificant in the known switching cabinet. In particular, it is complicated to remove the weatherproof roof for a transport and then to reinstall and fasten it after a transport. It is necessary to do so because for a transport, four eye bolts are inserted and screwed into corresponding bores provided in the corner regions on the upper frame profile of the upper cover of the switching cabinet. These eye bolts serve as so-called transport or crane eyes to which four transport cables can be connected, for example by carabiners, which cables can then be brought together centrally and picked up by a crane. The crane eyes are covered by the weatherproof roof when it is in place so that the weatherproof roof simultaneously provides protection from vandalism and theft. In the known switching cabinet, the crane eyes are formed as very heavy components, which must be screwed in separately and whose installation in the switching cabinet housing is complex, and they represent a considerable added weight.

### SUMMARY OF THE INVENTION

One object of this invention is to provide a switching cabinet with an attached roof that can be simply mounted on the switching cabinet housing in a detachable fashion and with a small number of parts. In the region of the attached roof, the switching cabinet according to this invention can have a transport device that is embodied in a weight-saving and material-saving fashion, but also that permits essentially the same ultimate load as conventional eye bolts.

This object of this invention can be attained by a switching cabinet with defining characteristics described in this specification and in the claims, as related to advantageous modifications of the switching cabinet according to this invention.

Consequently, the transport eyes are composed of angle elements. The angle elements each have one leg, which protrudes from the upper cover plate and has a through bore, and one fastening leg oriented at an angle to the one leg. The fastening legs of at least a portion of the angle elements each have a fastening region with which the angle element is attached to the top surface of the switching cabinet housing. In addition, the angle elements each have a holding region with which the angle elements engage behind an edge profile formed onto the mounted roof.

The roof, which is attached to the switching cabinet housing can be detachably mounted to the switching cabinet housing in a simple fashion and with a small number of parts. In the region of the attached roof, the switching cabinet has a transport device that performs a double function. The angle elements provided with a through bore on one leg serve as transport or crane eyes and also the angle elements prevent the roof from being lifted off. The angle elements can be screwed, riveted, or welded to the switching cabinet housing in a simple manner. The angle elements, which are essentially of a bent metal plate of a predetermined thickness, can be weight-saving and material-saving. Depending on the installation position, the selection of the material, and the material thickness, the angle elements have essentially the same ultimate load as conventional eye bolts.

The holding region can be prestressed in a spring-elastic fashion in relation to the edge profile so that when the roof is in the mounted state, a counterpressure acts on the edge profile. This counterpressure secures the roof in an installed position.

A portion of the angle elements that are used only as transport devices can also be constructed with the leg that protrudes from the upper cover plate having a through bore. The fastening leg, which is oriented at an angle to the other leg, rests with essentially its entire area against the upper cover plate of the switching cabinet housing and is fastened to it. An angle element of this kind serves as a transport or crane eye, but does not help secure the roof.

In order to achieve a particularly high carrying capacity of the transport device, the legs of the angle elements or the legs of all of the angle elements can be oriented essentially in the direction of the diagonals of the upper cover plate. This diagonal orientation of the crane eyes makes it possible, with a low material consumption and the use of thinner materials, to achieve the same lifting loads as with the use of eye bolts because the force is always introduced into the planes of the plate independent of the cable angle during transport. In addition, the angle elements can be relatively small. In this case, the holding regions of the fastening legs of the angle elements that are used to secure the roof can reliably engage behind and secure the edge profile formed onto the attached roof.

The roof can have a flat roof plate, which protrudes beyond the upper cover plate of the switching cabinet housing at the edges, such as protruding with an edge profile beyond its front, rear, and side parts. The edge profile has a lateral bent section that is oriented toward the upper cover plate, such as toward the pedestal of the switching cabinet housing. The lateral bent section has a support that is angled in relation to it, oriented toward the middle of the upper cover plate of the switching cabinet housing. With the support, the roof rests on top of the edge region of the upper cover plate of the switching cabinet housing.

The support can have ventilation slots in order, for example, to permit the escape of warm air that has accumulated under the roof due to sun exposure. The ventilation slots can be situated in regions that extend at least partially parallel to the switching cabinet door, the back wall, and the side plates of the switching cabinet housing. In this instance, a plurality of ventilation slots can extend perpendicular to the switching cabinet door, the back wall, and the side plates of the switching cabinet housing.

According to one embodiment of this invention, the support of the edge profile formed onto the roof can be affixed between the fastening legs of at least two angle elements and the upper cover plate of the switching cabinet housing. This permits a securing feature to be produced on at least one side, which prevents the roof from being lifted off from the switching cabinet housing.

At least two of the angle elements can protrude beyond a circumference boundary of the upper cover plate of the switching cabinet housing with at least a part of the holding regions of the fastening legs. The protruding part of the fastening legs can thus be used to provide a securing feature on one side into which the roof can be simply hooked during installation, preferably in a position that is tilted in relation to the upper cover plate.

In order to effectively prevent unauthorized persons from sliding the roof in relation to the switching cabinet housing, it is possible for a locking projection, which extends from the roof toward the bottom frame of the switching cabinet, to be formed onto the region of the edge profile of the roof oriented toward the switching cabinet door. When the switching cabinet door is closed, this locking projection extends into the intermediate region between the switching cabinet door and the switching cabinet housing. This prevents the roof from sliding toward the switching cabinet door in relation to the upper cover plate when the switching cabinet door is closed. This simple measure makes it unnecessary to secure the roof with screw connections. This significantly reduces the complexity of installation and possibly also removal, and also achieves a savings in material.

In order to also effectively prevent unauthorized persons from lifting the roof up from the switching cabinet housing, the edge of the switching cabinet door associated with the upper cover plate of the switching cabinet housing can be bent toward the switching cabinet housing. In this case, the locking projection extending from the roof toward the bottom frame of the switching cabinet is bent toward the switching cabinet door at its bottom end. If an unauthorized person should attempt to lift the roof up in the front region associated with the switching cabinet door, the two opposing bent sections of the closed switching cabinet door and the locking projection can contact each other, preventing further lifting.

The portion of the angle elements, which are used in their double function as transport or crane eyes and as roof securing elements, can also be constructed with the fastening region of the fastening leg of the angle element resting against the upper cover plate of the switching cabinet housing and being fastened to it. The holding region of the fastening leg is spaced apart from the upper cover plate of the switching cabinet housing by a distance that essentially corresponds to the height of the support of the edge profile of the roof. In this instance, the support of the edge profile formed onto the roof can be inserted in a simple fashion into the intermediate region between the upper cover plate and the holding region of the fastening leg of the angle element by sliding it relative to the upper cover plate, which effectively prevents the roof from being lifted.

According to one embodiment of this invention, at least two angle elements of a first type are situated on the upper cover plate in the region of the rear wall remote from the switching cabinet door. In addition, at least two angle elements of a second type are situated in the region of the door of the switching cabinet housing and are fastened there.

In this case, the angle elements of the first type are embodied and positioned with the fastening legs resting with their fastening regions against the upper cover plate of the switching cabinet housing and fastened to it. The holding regions are spaced apart from the upper cover plate of the switching cabinet housing and protrude beyond the circumference boundary of the upper cover plate. Thus, it is possible to securely fix the support of the edge profile between the fastening legs of the two angle elements of the first type and the upper cover plate of the switching cabinet housing.

In this case, the angle elements of the second type have fastening legs that rest with essentially their entire area against the upper cover plate of the switching cabinet housing.

In order to produce a broadened support area between the edge profile formed onto the roof and the upper side of the switching cabinet housing, the support of the edge profile, which is embodied in the region between the two angle elements of the first type, can protrude with a protruding support region in the direction toward the middle of the upper cover plate of the switching cabinet housing.

For a simple installation, the roof can be placed onto the upper cover plate of the switching cabinet housing in a position in which the roof is offset by a certain amount in the direction toward the back wall of the switching cabinet. In this rearward-shifted position, the support of the edge profile of the roof in the region of the rear wall remote from the switching cabinet door is shifted in the direction pointing out from the rear wall. At this point, the support of the edge profile does not engage with the holding regions of the fastening legs of the angle elements of the first type. When the roof is slid toward the switching cabinet door, such as toward the front, the support of the edge profile engages with the holding regions of the fastening legs of the angle elements of the first type, thus securing the roof in a way that prevents it from being lifted.

According to a second preferred embodiment, at least two angle elements can be situated on the upper cover plate in the region of the back wall remote from the switching cabinet door while at least two other angle elements can be situated in the region of the door of the switching cabinet housing. In this case, the angle elements are all of the same type, which can correspond to the first type of the first preferred embodiment. The angle elements can have the fastening legs resting with their fastening regions on the upper cover plate of the switching cabinet housing and being fastened to it. The holding regions are spaced apart from the upper cover plate of the switching cabinet housing. The support of the edge profile can be affixed between the fastening legs of the angle elements and the upper cover plate of the switching cabinet housing.

In order to permit a simple installation and also a simple removal of the roof as needed, the support of the edge profile can have recesses that are formed into it adjacent to the angle elements in the direction toward the rear wall of the switching cabinet housing and can be embodied so that they correspond to the holding regions of the fastening legs of the angle elements.

For a simple installation, the roof can be placed onto the upper cover plate of the switching cabinet housing in a position in which the roof is offset by a certain amount in the direction toward the switching cabinet door. In this position, the recesses in the support of the edge profile are flush with the holding regions of the fastening legs of the angle elements. At this point, the support of the edge profile does not engage with the holding regions of the fastening legs of the angle elements. When the roof is slid toward the back wall of the switching cabinet housing, the support of the edge profile engages with the holding regions of the fastening legs, thus securing the roof in a way that prevents it from being lifted.

The locking projection extending from the roof in the direction toward the bottom frame of the switching cabinet housing can strike against the switching cabinet housing when the roof is slid toward the rear wall of the switching cabinet housing. This limits a sliding of the roof in the direction toward the back wall of the switching cabinet and also prevents the roof from being slid toward the switching cabinet door when the door is closed.

### BRIEF DESCRIPTION OF THE DRAWINGS

This invention is described in greater detail in view of two preferred embodiments, wherein:

FIG. 1 is a schematic, perspective view of a switching cabinet with a switching cabinet housing to which a switching cabinet door, a pedestal, and a roof are attached;

FIG. 2 is a schematic top view of a switching cabinet according to one embodiment in which a roof is placed onto the upper horizontal cover plate of the switching cabinet housing and secured by angle elements and the roofplate is omitted from the drawing to provide an unobstructed view of the edge profile formed onto the roof and the placement of two different types of angle elements;

FIG. 3 is a schematic, partially sectional side view of an angle element of one type as shown in FIG. 2;

FIG. 4 is a schematic, partially sectional side view of an angle element of another type as shown in FIG. 2;

FIG. 5 is a schematic, sectional side view of the roof region of the switching cabinet shown in FIG. 2;

FIG. 6 is a schematic, enlarged sectional side view of the part labeled IV in FIG. 5; and

FIG. 7 is a schematic top view of a switching cabinet according to another embodiment in which a roof is placed onto the upper horizontal cover plate of the switching cabinet housing and secured by angle elements and the roof plate is omitted from the drawing in order to give an unobstructed view of the edge profile formed onto the roof and the placement of four angle elements of a first type.

### DETAILED DESCRIPTION OF THE INVENTION

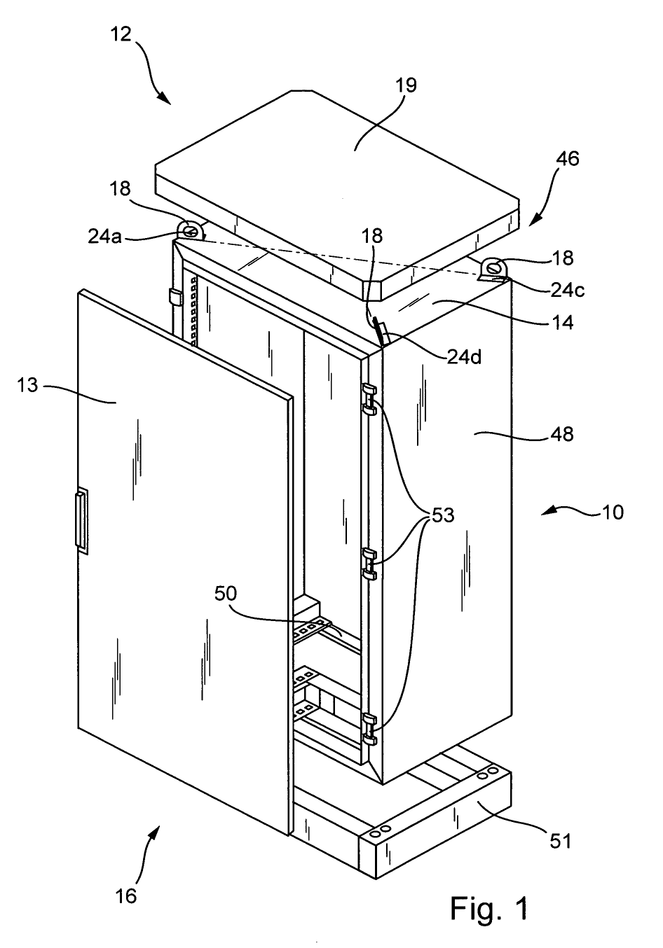

FIG. 1 is a schematic, perspective view of a switching cabinet with a switching cabinet housing 10. The switching cabinet housing 10 is delimited at its top 12 by an upper cover plate 14 extending horizontal to the floor (not shown). At the front side 16, the switching cabinet has a switching cabinet door 13 mounted to hinges 53 attached to the switching cabinet housing. At the lower end, the switching cabinet housing 10 is placed with its bottom frame 50, which is open toward the bottom, onto a pedestal 51 with which the switching cabinet stands on the floor.

Four transport eyes 18, which are comprised of angle elements, are attached to the top 12 of the switching cabinet housing 10, of which FIG. 1 shows only the angle elements labeled with the reference numerals 24a, 24c, and 24d. At the top 12 of the switching cabinet housing 10, a weatherproof roof 19 is placed onto the upper horizontal cover plate 14 and detachably connected to the switching cabinet housing 10. In the mounted state (not shown in FIG. 1), the roof 19 covers the transport eyes 18.

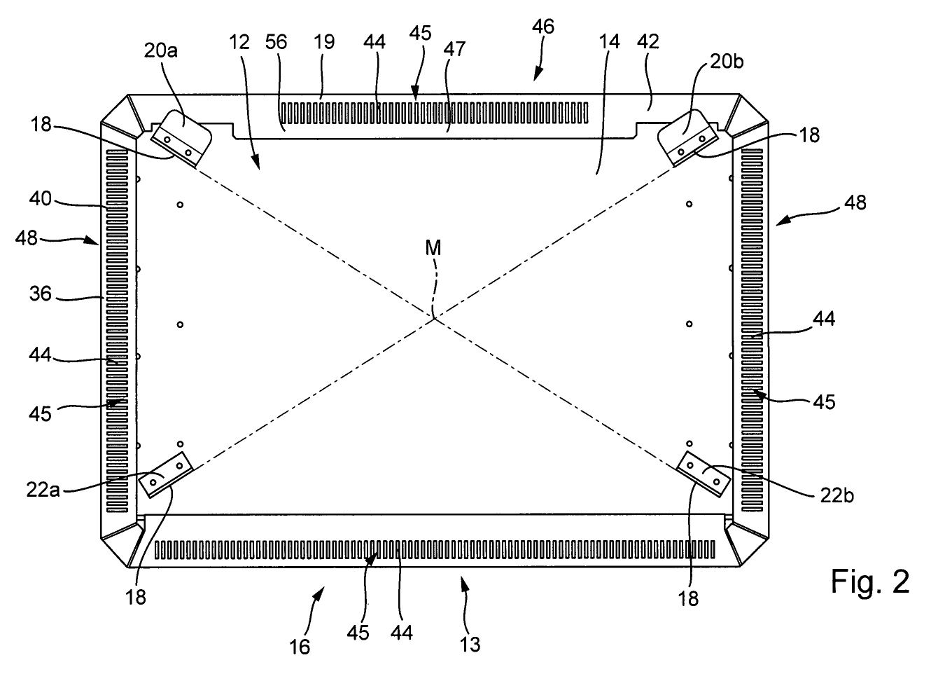

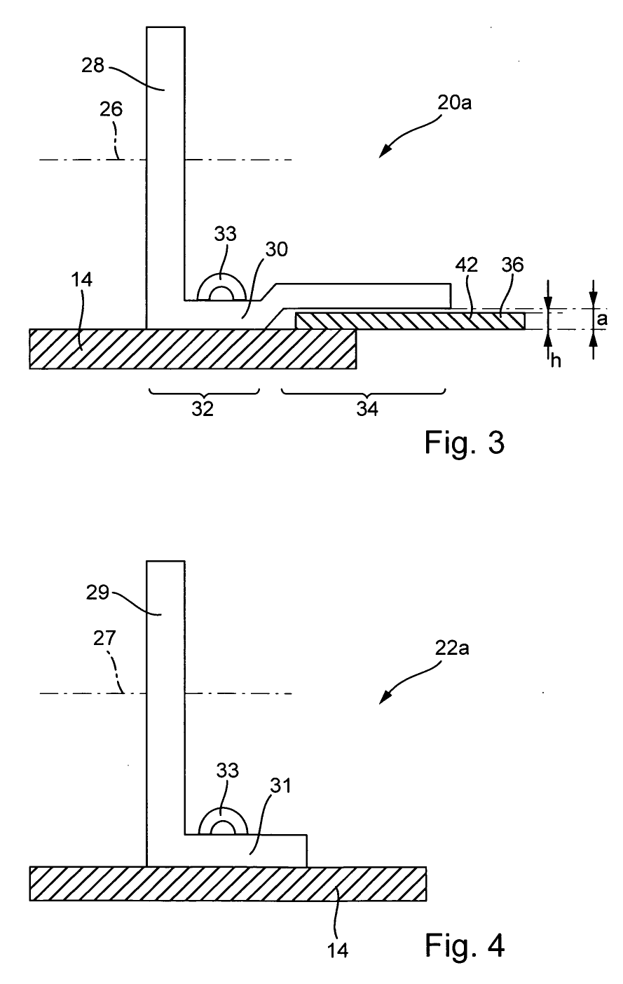

FIG. 2 is a schematic top view of a switching cabinet according to a first preferred embodiment in which the roof 19 is placed onto the upper horizontal cover plate 14 of the switching cabinet housing 10 and secured by angle elements 20a, 20b of a first type, which will be described in greater detail in conjunction with FIG. 3. The angle elements 22a and 22b of a second type, which differs from the first type, and will be described in greater detail in conjunction with FIG. 4, are not used to secure the roof 19, but only as transport or crane eyes. The roof plate of the roof 19 is omitted from in FIG. 2 in order to give an unobstructed view of the edge profile 36 formed onto the roof 19 and the placement of the angle elements 20a, 20b of the first type and the angle elements 22a, 22b of the second type.

Two angle elements 20a and 20b of the first type are situated on the upper horizontal cover plate 14 in the region of or near the back wall 46 remote from the switching cabinet door 13, in the associated corner regions of the cover plate 14.

Two angle elements 22a and 22b of the second type are situated on the upper horizontal cover plate 14 in the region of or near the switching cabinet door 13 of the switching cabinet housing 10 in the associated corner regions of the cover plate 14 and fastened there.

FIG. 3 is a schematic, partially sectional side view of an angle element 20a of the first type shown in FIG. 2. The angle elements 20a and 20b shown in FIG. 2 have the same embodiment. Only the angle element 20a is described below in conjunction with FIG. 3. One leg 28 protrudes perpendicular to the upper horizontal cover plate 14. The leg 28 has a through bore 26 that passes through it in the perpendicular direction for the engagement of carabiners.

A fastening leg 30, which adjoins the leg 28 at right angles, extends parallel to the upper horizontal cover plate 14. Adjoining the leg 28, the fastening leg 30 has a fastening region 32 with which the angle element 20a is attached to the upper horizontal cover plate 14 of the switching cabinet housing 10. For this purpose, a rivet connection 33 is shown in the embodiment shown in FIG. 3. Alternatively, a screw connection or a welded connection (not shown) could also be provided. In the direction of the free end of the fastening leg 30, the leg has a holding region 34, which adjoins the fastening region 32 and with which the fastening leg 30 engages behind an edge profile 36 formed onto the roof 19.

In one embodiment (not shown), the holding region 34 can be prestressed in a spring-elastic fashion relative to the edge profile 36 so that when the roof is in the mounted state, a counterpressure acts on the edge profile 36.

The holding region 34 of the fastening leg 30 is spaced apart from the upper horizontal cover plate 14 of the switching cabinet housing 10 by a distance a, which corresponds essentially to the height h of the edge profile 36 of the roof 19. The distance a between the holding region 34 of the fastening leg 30 and the cover plate 14 can be slightly greater than the height h of the edge profile 36 so that the edge profile 36 can engage in the intermediate region between the holding region 34 of the fastening leg 30 and the cover plate 14 and so that it is also possible for the edge profile 36 to be inserted in a tilted fashion.

In an alternative embodiment (not shown), the holding region 34 of the fastening leg 30 can protrude completely beyond the cover plate 14. In this case, the fastening region of the roof 19 can be cut away in the region of the fastening legs 30 so that the installation procedure can be carried out by a tilting motion.

In another embodiment (not shown), the fastening leg 30 can be angled downward in the holding region 34 so that as in the embodiment described above, the installation can be carried out by a tilting procedure, but in the mounted state, a spring action secures the roof 19 firmly against the cover plate 14 of the housing with a slight counterpressure.

As shown in FIG. 2 in combination with FIG. 3, the angle elements 20a and 20b of the first type situated on the upper horizontal cover plate 14 in the region of the back wall 46 of the switching cabinet protrude with a part of the holding region 34 of the respective fastening leg 30 beyond the circumference boundary of the upper horizontal cover plate 14 of the switching cabinet housing 10. The support 42 of the edge profile 36 is situated between the fastening legs 30 of the two angle elements 20a and 20b and the upper horizontal cover plate 14 of the switching cabinet housing 10.

For installation, the roof 19 can be placed onto the upper horizontal cover plate 14 of the switching cabinet housing 10 in a position shifted toward the rear (not shown). A tilting is thus possible in which the front part of the roof 19 oriented toward the switching cabinet door is raised relative to the rear part oriented toward the back wall 46. In this position, the support 42 of the edge profile 36 of the roof 19 is situated and shifted rearward in the direction pointing perpendicularly out from the back wall 46. At this point, the support 42 of the edge profile 36 does not engage with the holding regions 34 of the fastening legs 30 of the angle elements 20a and 20b. When the roof 19 is slid in the direction toward the switching cabinet door 13, the support 42 of the edge profile 36 engages with the holding regions 34 of the fastening legs 30 of the angle elements 20a and 20b.

FIG. 4 is a schematic, partially sectional side view of an angle element 22a of the second type shown in FIG. 2. The angle elements 22a and 22b shown in FIG. 2 have the same embodiment. Only the angle element 22a will be described below in conjunction with FIG. 4. One leg 29 protrudes perpendicular to the upper horizontal cover plate 14. The leg 29 has a through bore 27 that passes through it in the perpendicular direction for the engagement of a carabiner. A fastening leg 31, which adjoins the leg 29 at right angles, extends parallel to the upper horizontal cover plate 14. To this extent, the angle element 22a of the second type corresponds to the angle element 20a of the first type shown in FIG. 3.

By contrast with the angle element 20a of the first type shown in FIG. 3, in the angle element 22a of the second type shown in FIG. 4, the entire fastening leg 31 rests against the upper horizontal cover plate 14 of the switching cabinet housing 10 and is fastened to it. For this purpose, a rivet connection 33 is shown in the embodiment of FIG. 4. Alternatively, a screw connection or a welded connection (not shown) could also be provided.

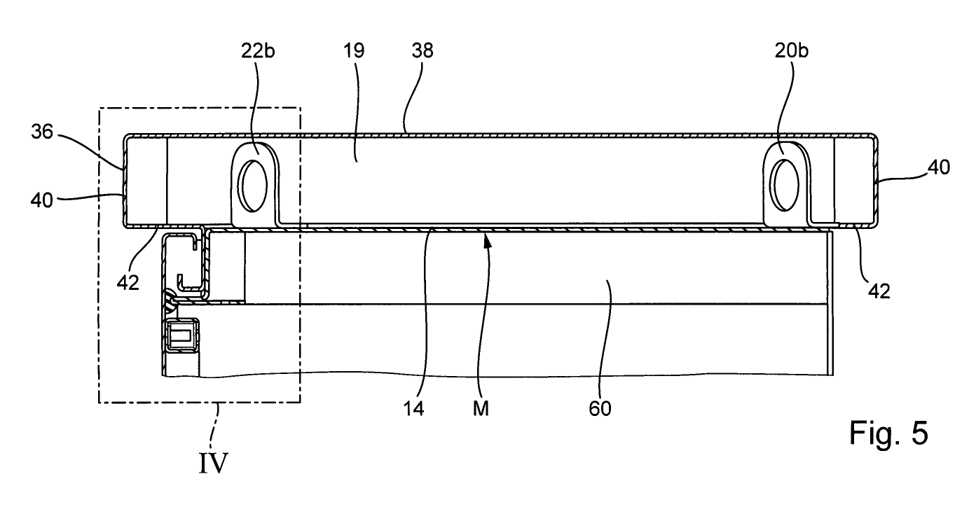

FIG. 5 is a schematic, sectional side view of the roof region of the switching cabinet shown in FIG. 2.

The roof 19 has a flat roof plate 38, which protrudes with an edge profile 36 beyond the edges of the upper horizontal cover plate 14 of the switching cabinet housing 10, as shown in FIG. 2. The edge profile 36 has a lateral bent section 40 extending around its edge, oriented vertically toward the upper horizontal cover plate 14 of the switching cabinet housing 10. The lateral bent section 40 has a support 42 extending perpendicular to it in the direction of the middle M of the upper horizontal cover plate 14 of the switching cabinet housing 10 and parallel to the upper horizontal cover plate 14. With the support 42, the roof 19 rests on the edge region of the upper horizontal cover plate 14 of the switching cabinet housing 10.

The upper horizontal cover plate 14 rests on an upper framework of the switching cabinet housing 10 of which the upper vertical strut 60 is shown in FIG. 5.

As shown in FIG. 2 in combination with FIG. 3, the support 42 of the edge profile 36 is affixed between the fastening legs 30 of the two angle elements 20a and 20b and the upper horizontal cover plate 14 of the switching cabinet housing 10.

The support 42 has a plurality of ventilation slots 44, which are positioned in regions 45 that extend parallel to the switching cabinet door 13, the back wall 46, and the side plates 48 of the switching cabinet housing 10. The ventilation slots 44 themselves extend perpendicular to the switching cabinet door 13, the back wall 46, and the side plates 48 of the switching cabinet housing 10.

The legs 28 of the angle elements 20a, 20b and 22a, 22b are essentially oriented in the direction of the two diagonals D1 and D2 of the upper horizontal cover plate 14 that are shown in FIG. 2.

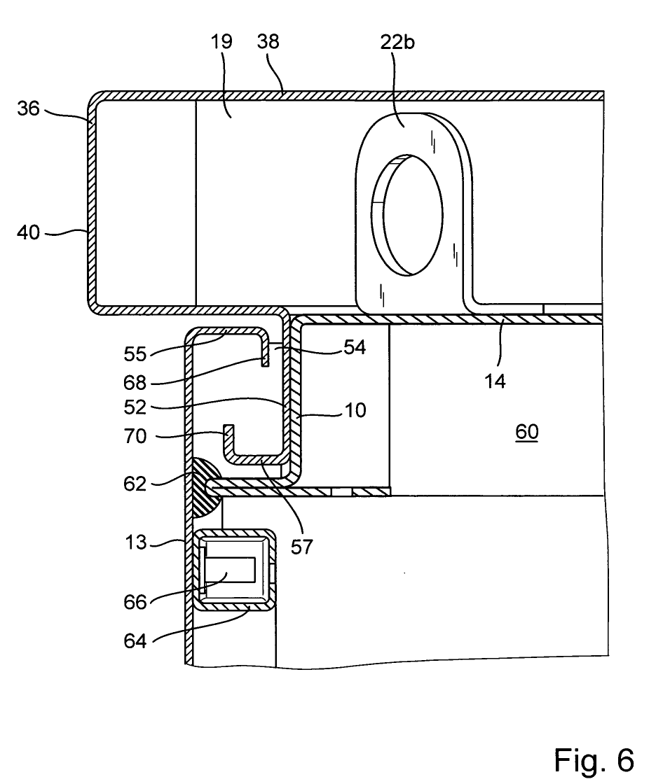

FIG. 6 is a schematic, enlarged sectional side view of the part labeled IV in FIG. 5.

A locking projection 52, which extends perpendicularly from the roof 19 toward the bottom frame 50 of the switching cabinet, is formed onto the region of the edge profile 36 of the roof 19 oriented toward the switching cabinet door 13. This locking projection 52 extends into the intermediate region 54 between the switching cabinet door 13 and the switching cabinet housing 10. When the switching cabinet door 13 is closed, as shown in FIG. 6, the roof 19 is prevented from sliding parallel to the upper horizontal cover plate 14 in the direction toward the switching cabinet door 13.

In the position shown in FIG. 6, the switching cabinet door 13 rests firmly against a seal 62, which is mounted on the switching cabinet housing 10 and extends around the door opening. The switching cabinet door has a tubular door frame 64 to which the door plate is fastened by a bolt 66 welded onto it.

The edge of the switching cabinet door 13 oriented toward the upper horizontal cover plate 14 of the switching cabinet housing 10 is bent at right angles toward the switching cabinet housing 10, thus forming a bent section 55. A bent end region 68 is thus formed onto the bent section 55 and extends perpendicular to it in the direction toward the pedestal 51. The lower end of the locking projection 52, which extends perpendicularly from the roof 19 toward the bottom frame of the switching cabinet, is bent perpendicularly toward the switching cabinet door 13, thus forming a bent section 57. An end region 70 is thus formed onto the bent section 57 and extends perpendicular to it in the direction toward the roof 19.

As shown in FIG. 2, in the region between the two angle elements 20a and 20b, the support 42 of the edge profile 36 protrudes with a projecting support region 56 in the direction toward the middle M of the upper horizontal cover plate 14 of the switching cabinet housing 10 and forms a broadened support surface 47 of the roof 19 at the edge region of the cover plate 14.

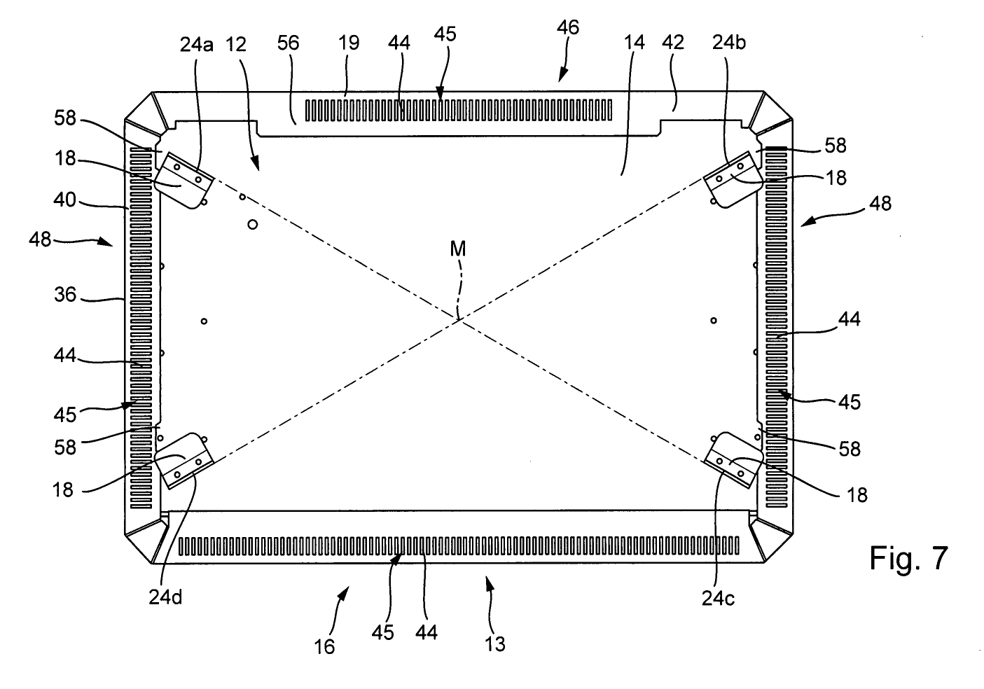

FIG. 7 is a schematic top view of a switching cabinet according to a second preferred embodiment in which a roof 19 is placed onto the upper horizontal cover plate 14 of the switching cabinet housing 10 and is secured by angle elements 24a, 24b, 24c, and 24d. The roof plate has also been omitted from the drawing in FIG. 7 in order to give an unobstructed view of the edge profile 36 formed onto the roof 19 and of the placement of four angle elements 24a, 24b, 24c, and 24d of the first type.

FIG. 7 shows components, having the same reference numerals in FIG. 2 and described above in conjunction with FIG. 2. These components will not be described again because they have the same functionality as the components with the same reference numerals shown in FIG. 2. The description below will concentrate solely on the differences from the embodiment shown in FIG. 2.

Two angle elements 24a and 24b of the first type described above in conjunction with FIG. 3 are situated on the upper horizontal cover plate 14 in the region of or near the back wall 46 in the associated corner regions of the cover plate 14. Two other angle elements 24c and 24c of the same first type are situated in the region of or near the switching cabinet door 13 in the associated corner regions of the cover plate 14.

Like the angle element 20a described in conjunction with FIG. 3, the angle elements 24a, 24b, 24c, and 24d have fastening legs 30 that rest with their fastening regions 32 on the upper horizontal cover plate 14 of the switching cabinet housing 10 and are fastened to it. The holding regions 34 are spaced apart from the upper horizontal cover plate 14 of the switching cabinet housing 10. The support 42 of the edge profile 36 is affixed between the fastening legs 30 of the angle elements 24a, 24b, 24c, and 24d and the upper horizontal cover plate 14 of the switching cabinet housing 10.

The support 42 of the edge profile 36 has four recesses 58 that are formed into it adjacent to the angle elements 24a, 24b, 24c, and 24d and offset from them in the direction toward the back wall 46 of the switching cabinet housing 10. The recesses 58 are embodied so that they correspond to the holding regions 34 of the fastening legs 30 of the angle elements 24a, 24b, 24c, and 24d.

For installation, the roof 19 can be placed onto the upper horizontal cover plate 14 of the switching cabinet housing 10 in a position (not shown) in which the recesses 58 in the support 42 of the edge profile 36 are flush with the holding regions 34 of the fastening legs 30 of the angle elements 24a, 24b, 24c, and 24d. In this position, the support 42 of the edge profile 36 does not engage with the holding regions 34 of the fastening legs 30 of the angle elements 24a, 24b, 24c, and 24d. When the roof 19 is slid toward the back wall 46 of the switching cabinet housing 10, the support 42 of the edge profile 36 can be engaged with the holding regions 34 of the fastening legs 30 of the angle elements 24a, 24b, 24c, and 24d.

The locking projection 52 shown in FIG. 6, which extends perpendicularly from the roof 19 toward the bottom frame 50 of the switching cabinet housing 10, strikes against the switching cabinet housing 10 when the roof 19 is slid toward the back wall 46 of the switching cabinet housing 10.

German Patent Reference 10 2007 057 381.4-34, the priority document corresponding to this invention, and its teachings are incorporated, by reference, into this specification.

What is claimed is:

1. A switching cabinet with a switching cabinet housing (10) delimited at a top (12) by an upper cover plate (14) and having at least one switching cabinet door (13) on a front surface with a plurality of transport eyes (18) attached to the top (12) of the switching cabinet housing (10) and that is coverable by a detachably fastenable roof (19), the switching cabinet comprising:
the transport eyes (18) comprising angle elements (20a, 20b, 22a, 22b; 24a, 24b, 24c, 24d) each having one leg (28; 29) protruding from the upper cover plate (14) and a through bore (26; 27), and one fastening leg (30; 31) oriented at an angle to the one leg (28; 29), the fastening legs (30; 31) of at least a portion of the angle elements (20a, 20b; 24a, 24b, 24c, 24d) each having a fastening region (32) attached to the top (12) of the switching cabinet housing (10) and a holding region (34) engaging behind an edge profile (36) formed onto the mounted roof (19).

2. The switching cabinet as recited in claim 1, wherein the holding region (34) is prestressed in a spring-elastic fashion in relation to the edge profile (36) so that when the roof is in a mounted state a counterpressure acts on the edge profile (36).

3. The switching cabinet as recited in claim 2, wherein at least a portion of the angle elements (22a, 22b) each have the one leg (29), which protrudes from the upper cover plate (14) and have a through bore (27), and one fastening leg (31) oriented at an angle to the one leg (29), and the fastening legs (31) rest against and are fastened to the upper cover plate (14) of the switching cabinet housing (10).

4. The switching cabinet as recited in claim 3, wherein the one legs (28) of the angle elements (20a, 20b, 22a, 22b; 24a; 24b; 24c; 24d) are oriented in a direction of the diagonals (D1; D2) of the upper cover plate (14).

5. The switching cabinet as recited in claim 4, wherein the roof (19) has a flat roof plate (38) which protrudes beyond the edges of the upper cover plate (14) of the switching cabinet housing (10) with an edge profile (36) having a lateral bent section (40) extending around and oriented toward the upper cover plate (14) and having an angled support (42) oriented toward a middle (M) of the upper cover plate (14) of the switching cabinet housing (10), with which the roof (19) rests on an edge region of the upper cover plate (14) of the switching cabinet housing (10).

6. The switching cabinet as recited in claim 5, wherein the support (42) has ventilation slots (44) positioned in regions (45) that at least in some sections, extend parallel to the switching cabinet door (13), the back wall (46), and the side plates (48) of the switching cabinet housing (10).

7. The switching cabinet as recited in claim 6, wherein a plurality of ventilation slots (44) extend perpendicular to the switching cabinet door (13), the back wall (46), and the side plates (48) of the switching cabinet housing (10).

8. The switching cabinet as recited in claim 1, wherein the support (42) of the edge profile (36) is affixed between the fastening legs (30) of at least two angle elements (20a, 20b; 24a, 24b, 24c, 24d) and the upper cover plate (14) of the switching cabinet housing (10).

9. The switching cabinet as recited in claim 8, wherein at least two of the angle elements (20a, 20b) protrude beyond a circumference boundary of the upper cover plate (14) of the switching cabinet housing (10) with at least a part of the holding regions (34) of the fastening legs (30).

10. The switching cabinet as recited in claim 9, wherein a locking projection (52) which extends from the roof (19) toward a bottom frame (50) of the switching cabinet is formed onto a region of the edge profile (36) of the roof (19) oriented toward the switching cabinet door (13) and extends into the intermediate region (54) between the switching cabinet door (13) and the switching cabinet housing (10) so that when the switching cabinet door (13) is closed, the roof (19) is prevented from sliding toward the switching cabinet door (13) relative to the upper cover plate (14).

11. The switching cabinet as recited in claim 10, wherein the edge of the switching cabinet door (13) oriented toward the upper cover plate (14) of the switching cabinet housing (10) is bent toward the switching cabinet housing (10) and a lower end of the locking projection (52) which extends perpendicularly from the roof (19) toward the bottom frame of the switching cabinet is bent toward the switching cabinet door (13).

12. The switching cabinet as recited in one claim 11, wherein the fastening region (32) of the fastening leg (30) of the angle element (20a, 20b; 24a, 24b, 24c, 24d) rests against and is fastened to the upper cover plate (14) of the switching cabinet housing (10), the holding region (34) of the fastening leg (30) is spaced apart from the upper cover plate (14) of the switching cabinet housing (10) by a distance (a) corresponding to a height (h) of the support (42) of the edge profile (36) of the roof (19).

13. The switching cabinet as recited in claim 12, wherein at least two first angle elements (20a, 20b) with fastening legs (30) having fastening regions (32) rest against and are fastened to the upper cover plate (14) of the switching cabinet housing (10) and having the holding regions (34) spaced apart from the upper cover plate (14) of the switching cabinet housing (10) situated on the upper cover plate (14) in the region of the back wall (46) remote from the switching cabinet door (13), the holding regions (34) protrude beyond the circumferential boundary of the upper cover plate (14) and the support (42) of the edge profile (36) can be affixed between the fastening legs (30) of the two first angle elements (20a, 20b) and the upper cover plate (14) of the switching cabinet housing (10) and at least two second angle elements (22a; 22b) with fastening legs (31) which rest against the upper cover plate (14) of the switching cabinet housing (10) are situated on and fastened to the upper cover plate (14) near the switching cabinet door (13) of the switching cabinet housing (10).

14. The switching cabinet as recited in claim 13, wherein between the two first angle elements (20a; 20b), the support (42) of the edge profile (36) protrudes with a projecting support region (56) in the direction toward the middle of the upper cover plate (14) of the switching cabinet housing (10) and forms a broadened support surface (47).

15. The switching cabinet as recited in claim 14, wherein for installation, the roof (19) is positionable onto the upper cover plate (14) of the switching cabinet housing (10) so that the support (42) of the edge profile (36) of the roof (19) situated in the region of the back wall (46) remote from the switching cabinet door (13) is shifted in the direction pointing out from the back wall (46) and the support (42) of the edge profile (36) does not engage with the holding regions (34) of the fastening legs (30) of the first angle elements (20a; 20b), and the roof (19) is slidable toward the switching cabinet door (13) so that the support (42) of the edge profile (36) engages with the holding regions (34) of the fastening legs (30) of the first angle elements (20a; 20b).

16. The switching cabinet as recited in claim 12, wherein at least two angle elements (24a, 24b) are situated on the upper cover plate (14) near the back wall (46) remote from the switching cabinet door (13) while at least two other angle elements (24c, 24c) are situated near the switching cabinet door (13) of the switching cabinet housing (10), the angle elements (24a, 24b, 24c, 24d) have fastening legs (30) whose fastening regions (32) rest against and are fastened to the upper cover plate (14) of the switching cabinet housing (10) and whose holding regions (34) are spaced apart from the upper cover plate (14) of the switching cabinet housing (10), and the support (42) of the edge profile (36) is affixable between the fastening legs (30) of the angle elements (24a, 24b, 24c, 24d) and the upper cover plate (14) of the switching cabinet housing (10).

17. The switching cabinet as recited in claim 16, wherein the support (42) of the edge profile (36) has recesses (58) formed adjacent to the angle elements (24a, 24b, 24c, 24d) and offset toward the back wall (46) of the switching cabinet housing (10) and correspond to the holding regions (34) of the fastening legs (30) of the angle elements (24a, 24b, 24c, 24d).

18. The switching cabinet as recited in claim 17, wherein for installation, the roof (19) is positionable onto the upper cover plate (14) of the switching cabinet housing (10) so that the recesses (58) in the support (42) of the edge profile (36) are flush with the holding regions (34) of the fastening legs (30) of the angle elements (24a, 24b, 24c, 24d) and the support (42) of the edge profile (36) does not engage with the holding regions (34) of the fastening legs (30) of the angle elements, and the roof (19) is slidable toward the back wall (46) of the switching cabinet housing (10) so that the support (42) of the edge profile (36) can engage with the holding regions (34) of the fastening legs (30) of the angle elements (24a, 24b, 24c, 24d).

19. The switching cabinet as recited in claim 18, wherein the locking projection (52) which extends perpendicularly from the roof (19) toward the bottom frame (50) of the switching cabinet housing (10), strikes against the switching cabinet housing (10) when the roof (19) is slid toward the back wall (46) of the switching cabinet housing (10).

20. The switching cabinet as recited in claim 1, wherein at least a portion of the angle elements (22a, 22b) each have the one leg (29), which protrudes from the upper cover plate (14) and have a through bore (27), and one fastening leg (31) oriented at an angle to the one leg (29), and the fastening legs (31) rest against and are fastened to the upper cover plate (14) of the switching cabinet housing (10).

21. The switching cabinet as recited in claim 1, wherein the one legs (28) of the angle elements (20a, 20b, 22a, 22b; 24a; 24b; 24c; 24d) are oriented in a direction of the diagonals (D1; D2) of the upper cover plate (14).

22. The switching cabinet as recited in claim 1, wherein the roof (19) has a flat roof plate (38) which protrudes beyond the edges of the upper cover plate (14) of the switching cabinet housing (10) with an edge profile (36) having a lateral bent section (40) extending around and oriented toward the upper cover plate (14) and having an angled support (42) oriented toward a middle (M) of the upper cover plate (14) of the switching cabinet housing (10), with which the roof (19) rests on an edge region of the upper cover plate (14) of the switching cabinet housing (10).

23. The switching cabinet as recited in claim 1, wherein at least two of the angle elements (20a, 20b) protrude beyond a circumference boundary of the upper cover plate (14) of the switching cabinet housing (10) with at least a part of the holding regions (34) of the fastening legs (30).

24. The switching cabinet as recited in claim 5, wherein a locking projection (52) which extends from the roof (19) toward a bottom frame (50) of the switching cabinet is formed onto a region of the edge profile (36) of the roof (19) oriented toward the switching cabinet door (13) and extends into the intermediate region (54) between the switching cabinet door (13) and the switching cabinet housing (10) so that when the switching cabinet door (13) is closed, the roof (19) is prevented from sliding toward the switching cabinet door (13) relative to the upper cover plate (14).

25. The switching cabinet as recited in one claim 5, wherein the fastening region (32) of the fastening leg (30) of the angle element (20a, 20b; 24a, 24b, 24c, 24d) rests against and is fastened to the upper cover plate (14) of the switching cabinet housing (10), the holding region (34) of the fastening leg (30) is spaced apart from the upper cover plate (14) of the switching cabinet housing (10) by a distance (a) corresponding to a height (h) of the support (42) of the edge profile (36) of the roof (19).

26. The switching cabinet as recited in claim 5, wherein at least two first angle elements (20a, 20b) with fastening legs (30) having fastening regions (32) rest against and are fastened to the upper cover plate (14) of the switching cabinet housing (10) and having the holding regions (34) spaced apart from the upper cover plate (14) of the switching cabinet housing (10) situated on the upper cover plate (14) in the region of the back wall (46) remote from the switching cabinet door (13), the holding regions (34) protrude beyond the circumferential boundary of the upper cover plate (14) and the support (42) of the edge profile (36) can be affixed between the fastening legs (30) of the two first angle elements (20a, 20b) and the upper cover plate (14) of the switching cabinet housing (10) and at least two second angle elements (22a; 22b) with fastening legs (31) which rest against the upper cover plate (14) of the switching cabinet housing (10) are situated on and fastened to the upper cover plate (14) near the switching cabinet door (13) of the switching cabinet housing (10).

27. The switching cabinet as recited in claim 13, wherein for installation, the roof (19) is positionable onto the upper cover plate (14) of the switching cabinet housing (10) so that the support (42) of the edge profile (36) of the roof (19) situated in the region of the back wall (46) remote from the switching cabinet door (13) is shifted in the direction pointing out from the back wall (46) and the support (42) of the edge profile (36) does not engage with the holding regions (34) of the fastening legs (30) of the first angle elements (20a; 20b), and the roof (19) is slidable toward the switching cabinet door (13) so that the support (42) of the edge profile (36) engages with the holding regions (34) of the fastening legs (30) of the first angle elements (20a; 20b).

28. The switching cabinet as recited in claim 5, wherein at least two angle elements (24a, 24b) are situated on the upper cover plate (14) near the back wall (46) remote from the switching cabinet door (13) while at least two other angle elements (24c, 24c) are situated near the switching cabinet door (13) of the switching cabinet housing (10), the angle elements (24a, 24b, 24c, 24d) have fastening legs (30) whose fastening regions (32) rest against and are fastened to the upper cover plate (14) of the switching cabinet housing (10) and whose holding regions (34) are spaced apart from the upper cover plate (14) of the switching cabinet housing (10), and the support (42) of the edge profile (36) is affixable between the fastening legs (30) of the angle elements (24a, 24b, 24c, 24d) and the upper cover plate (14) of the switching cabinet housing (10).

29. The switching cabinet as recited in claim 16, wherein for installation, the roof (19) is positionable onto the upper cover plate (14) of the switching cabinet housing (10) so that the recesses (58) in the support (42) of the edge profile (36) are flush with the holding regions (34) of the fastening legs (30) of the angle elements (24a, 24b, 24c, 24d) and the support (42) of the edge profile (36) does not engage with the holding regions (34) of the fastening legs (30) of the angle elements, and the roof (19) is slidable toward the back wall (46) of the switching cabinet housing (10) so that the support (42) of the edge profile (36) can engage with the holding regions (34) of the fastening legs (30) of the angle elements (24a, 24b, 24c, 24d).
